(19) United States
(12) Patent Application Publication
(10) Pub. No.: US 2025/0343698 A1
(43) Pub. Date: Nov. 6, 2025

(54) LOWER LEVEL SECURITY SYSTEM AND METHOD

(71) Applicant: Lenovo (United States) Inc., Morrisville, NC (US)

(72) Inventors: Prateek BASU MALLICK, Dreieich (DE); Joachim LÖHR, Wiesbaden (DE); Shwetha SREEJITH, Bad Homburg (DE); Andreas KUNZ, Ladenburg (DE); Sheeba Backia Mary BASKARAN, Friedrichsdorf (DE)

(21) Appl. No.: 19/270,354

(22) Filed: Jul. 15, 2025

(51) Int. Cl. H04L 9/32; H04W 12/106; H04W 72/1268; H04W 72/231

(52) U.S. Cl. CPC H04L 9/3242; H04W 12/106; H04W 72/1268; H04W 72/231

(57) ABSTRACT

Various aspects of the present disclosure relate to a User Equipment (UE) configured to or operable to receive, from a network entity, a grant for a set of resources for an uplink transmission, cipher at least one medium access control-control element (MAC-CE), generate at least one message authentication code for integrity (MAC-I) for validating the at least one MAC-CE, and transmit, to the network entity, a first packet comprising the at least one MAC-CE and the at least one MAC-I using the set of resources.

### TECHNICAL FIELD

The present disclosure relates to wireless communications, and more specifically to secure wireless communications of medium access control-control elements (MAC-CEs) layer one (L1) information.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to receive, from a network entity, a grant for a set resources for an uplink transmission, cipher at least one MAC-CE, generate at least one Message Authentication Code for Integrity (MAC-I) for validating the at least one MAC CE, and transmit, to the network entity, a first packet comprising the at least one MAC CE and the at least one MAC-I using the set of resources.

A method performed or performable by a UE for wireless communication is described. The method may include receiving, from a network entity, a grant for a set of resources for an uplink transmission, ciphering at least one MAC-CE, generating at least one MAC-I for validating the at least one MAC CE, and transmitting, to the network entity, a first packet comprising the at least one MAC CE and the at least one MAC-I using the set of resources.

In some implementations of the UE and method described herein, the at least one MAC-CE is ciphered according to a keystream block.

In some implementations of the UE and method described herein, the keystream block is based in part on a System Frame Number (SFN) associated with the grant.

In some implementations of the UE and method described herein, the keystream block is based in part on a Sequence Number (SN) calculated according to the following equation: SN=SFN*10+Subframe Number.

In some implementations of the UE and method described herein, the keystream block is based at least in part on a time resource of the grant and a header of the first packet.

In some implementations of the UE and method described herein, the keystream block is based at least in part on a frequency resource of the grant.

In some implementations of the UE and method described herein, the at least one MAC-I is generated based in part on an SFN associated with the grant.

In some implementations of the UE and method described herein, the at least one MAC-I is based in part on a Sequence Number (SN) calculated according to the following equation: SN=SFN*10+Subframe Number.

In some implementations of the UE and method described herein, the first packet includes a plurality of MAC-CEs and one MAC-I.

In some implementations of the UE and method described herein, the first packet includes a plurality of MAC-CEs and a plurality of MAC-Is, and wherein each MAC-I of the plurality of MAC-CEs is associated with a respective MAC-CE of the plurality of MAC-CEs.

In some implementations of the UE and method described herein include ciphering L1 data, and transmitting, to the network entity, the ciphered L1 data in a second packet comprising a second MAC-I associated with the L1 data.

In some implementations of the UE and method described herein, the at least one MAC-CE and the L1 data are each ciphered according to a same cipher key.

An NE (e.g., a base station) for wireless communication is described. The NE may be configured to, capable of, or operable to perform one or more operations as described herein. For example, the NE may be configured to, capable of, or operable to transmit, to a User Equipment (UE), a grant for a set of resources for an uplink transmission, receive, from the UE, a first packet comprising at least one MAC-CE and at least one MAC-I using the set of resources of the grant, decipher the at least one MAC-CE, and validate the at least one MAC-I.

### BRIEF DESCRIPTION OF THE DRAWINGS

FIG. 1 illustrates an example of a wireless communications system in accordance with aspects of the present disclosure.

FIG. 2 illustrates an example of a process for secure lower level communications in accordance with aspects of the present disclosure.

FIG. 3 illustrates an example of a security key generation hierarchy in accordance with aspects of the present disclosure.

FIG. 4 illustrates an example of generating a MAC-I in accordance with aspects of the present disclosure.

FIG. 5 illustrates an example of ciphering and integrity protection using information in addition to a security key in accordance with aspects of the present disclosure.

FIG. 6 illustrates an example of a format of a count field in accordance with aspects of the present disclosure.

FIG. 7 illustrates an example of partitioning time parts associated with a 14 bit SN in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a NE in accordance with aspects of the present disclosure.

FIG. 11 illustrates a flowchart of method performed by a UE in accordance with aspects of the present disclosure.

FIG. 12 illustrates a flowchart of method performed by a NE in accordance with aspects of the present disclosure.

### DETAILED DESCRIPTION

The present disclosure provides solutions for securing lower-layer MAC-CEs and physical layer or L1 messages, in cases where no security context is available. In some cases, information included in MAC-CEs and in physical layer or L1 signaling (e.g., physical uplink control channel (PUCCH) transmission, downlink control information (DCI), paging messages, system information (SI), etc.) is communicated without any security (e.g., encryption or integrity protection). Such signaling may be used to compromise user information and/or to initiate a denial of service (DOS) attacks. Although a DOS attack may not directly compromise data privacy or authentication, it is desirable to reduce opportunities for DOS attacks.

The following examples show how MAC-CEs can be exploited to compromise sensitive user information. In some examples, a logical channel group identity (LCG ID) is used to group logically similar service types for better management of resources. An attacker may infer the type of service a group of UEs is utilizing, as well as their usage patterns or preferences, based on the LCG ID. In some other examples, a cell radio network temporary identifier (C-RNTI) is used to identify a UE within a cell. By monitoring and analyzing C-RNTI usage, an attacker may correlate it with other intercepted parameters to approximate a location of the UE. If C-RNTI usage is observed across multiple radio access network (RAN) nodes, the attacker may derive increasingly precise location information for the UE. In other examples, a UE contention resolution ID may be used to resolve contention during a random access procedure to enable a RAN to correctly identify a UE. However, if an attacker monitors the use of the UE contention resolution ID during one or more message exchange during the random access procedure, the attacker may be able to track the UE's access attempts to the network (e.g., the RAN). When combined with additional information, such as knowledge of a network topology and/or cell deployment locations, can further increase the attacker's ability to infer a location of the UE.

Additionally, or alternatively, in some examples, a timing advance group identity (TAG ID) is used to identify a group of serving cells to facilitate synchronization between a UE and cells that may server as potential handover targets for the UE. If an attacker detects frequent updates to the TAG ID associated with the UE, the attacker may infer that the UE may be in a mobility scenario. Additionally, based on fluctuations in the timing advance (TA) values assigned to the UE, and the attacker's ability to detect such fluctuations, the attacker may gain some degree of precision in estimating the location of the UE within the neighboring serving cells.

Additionally, or alternatively, in some examples a TA command is used to inform the UE on the TA required to synchronize with serving cells. By monitoring changes in TA values, an attacker may be able to track the UE. For example, if a TA associated with the UE remains static for an extended period of time (e.g., during daytime hours), it may suggest that the UE is located in an office. Similarly, if the TA remains static for an extended period of time (e.g., during evening or nighttime hours), it may be indicative that the UE is at a residential location. For example, an attacker can deduce that the UE is at home.

An attacker may manipulate (e.g., modify) TA information, and cause desynchronization between a UE and a base station (e.g., a target cell). In some cases, a target configuration ID may be tampered with, leading to a connection failure between the UE and the target cell. Additionally, if a next hop chaining counter (NCC) value (e.g., a keySetChangeIndicator value) and/or at least one algorithm associated with the target cell are carried by an L1/L2 Triggered Mobility (LTM) Cell Switch Command MAC-CE (e.g., carrying information to switch a serving cell for a UE), one or both could be subject to tampering by the attacker, and if the UE accepts the modified NCC value, this may result in an out-of-sync, key mismatch or security negotiation failure between the UE and the target cell. In some other examples, if the NCC value (e.g., keySetChangeIndicator) and/or at least one algorithm associated with the target cell are carried by the LTM Cell Switch Command MAC-CE, one or both could be subject to tampering. If the UE accepts a modified NCC value, this may result in an out-of-sync, key mismatch or security negotiation failure between the UE and the target cell.

In some wireless communication systems, security procedures may be performed at a packet data convergence protocol (PDCP) layer of a protocol stack of an entity (e.g., a base station, a UE, or both). The PDCP layer may be above a MAC layer (e.g., an L2 layer of the protocol stack) and physical (PHY) layer (e.g., an L1 layer of the protocol stack). Since a security context for access stratum (AS) in both the base station and the UE is exclusively established (e.g., available) at a radio resource control (RRC) layer and performed at the PDCP layer, it may be utilized to protect the lower layer signaling. Further, applying conventional PDCP layer security procedures to protect MAC-CEs may introduce significant delays. This is because L2 (e.g., MAC) and L1 (e.g., PHY) information may be generated after the UE received an uplink grant. As a result, applying security at the PDCP layer may not occur in time for the protected data to be included in an UL transmission. Similar problems arise for downlink transmissions, where applying security at the PDCP layer of the base station may likewise result in unacceptable transmission delay.

Implementations of the present disclosure may address one or more of the problems identified above by applying security to MAC and PHY layer data at a lower layer than the PDCP layer. In some implementations, security keys may be used to generate at least one Message Authentication Code for Integrity (MAC-I) and to cipher at least one MAC-CE and L1/PHY data at a UE. The MAC-I generation and MAC-CE ciphering may be applied at the MAC layer, thereby avoiding PDCP operations for security and reducing delay compared to conventional security practices.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

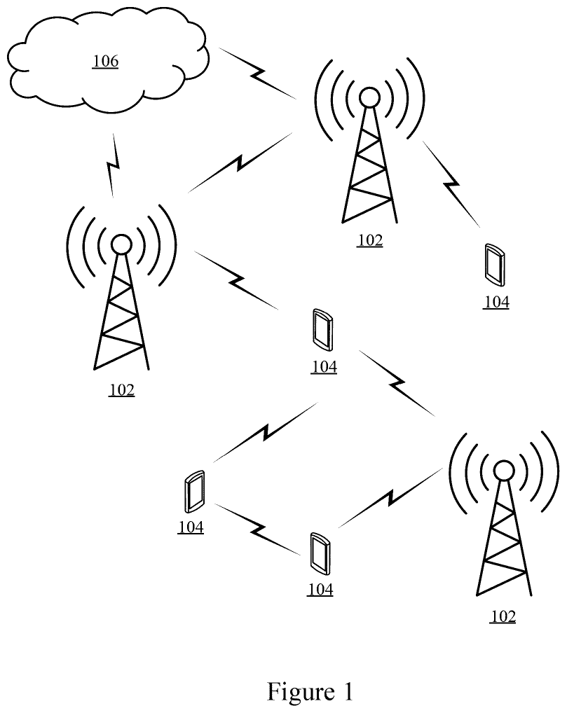

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., p=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe.

A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

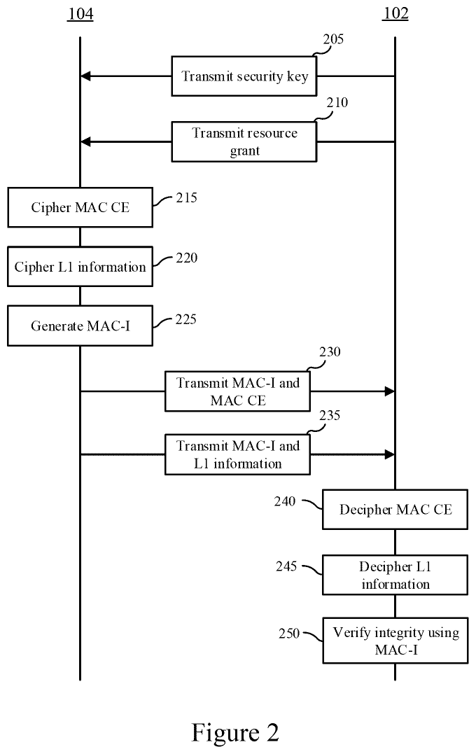

FIG. 2 illustrates an example of a process for secure lower-level communications in accordance with aspects of the present disclosure. The operations of the process of FIG. 2 may be performed by a UE 104 and an NE 102.

Implementations relate to applying security to lower level, e.g., level 1 (L1) or PHY layer and level 2 (L2) or MAC layer information that is transmitted from a UE 104 to an NE 102. Security may be applied to the information using a security key that may be received from an NE 102, and/or a security key that is generated by the UE 104 based on a security received from the NE 102. Therefore, an NE 102 may transmit a security key to a UE 104 at 205. The security key may be a key from a security key generation hierarchy.

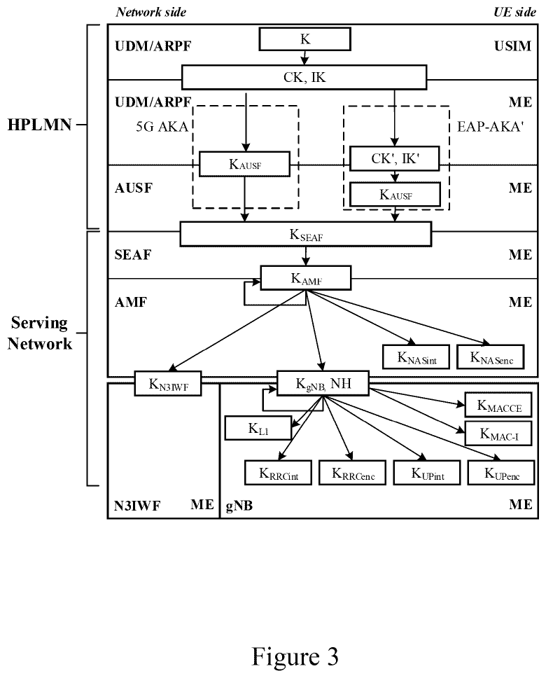

FIG. 3 illustrates an example of a security key generation hierarchy in accordance with aspects of the present disclosure. The User Subscriber Identity Module (USIM) and the Authentication Credential Repository and Processing Function (ARPF) within the 5G Core both include a long-term key K. K may be 128 or 256 bits long. All other keys used for ciphering and integrity may be derived from K. During authentication, the USIM generates CK and IK and sends these to Mobile Equipment (ME), e.g., UEs 104.

The keys related to authentication include the following keys: K, CK/IK. In case of Extensible Authentication Protocol-Authentication and Key Agreement (EAP-AKA), the keys CK′, IK′ are derived from CK, IK.

The key hierarchy includes the following keys: K_{AUSF}, K_{SEAF}, K_{AMF}, K_{NASint}, K_{NASenc}, K_{N3IWF}, K_{gNB}, K_{RRCint}, K_{RRCenc}, K_{UPint} and K_{UPenc}.

For an Authentication Server Function (AUSF) in a home network: K_{AUSF} is a key derived by ME and AUSF from CK′, IK′ in the case of EAP-AKA′, and CK′ and IK′ is received by AUSF from an Authentication Credential Repository and Processing Function (ARPF); or by the ME and ARPF from CK, IK in the case of 5G AKA, K_{AUSF} is received by the AUSF from the ARPF. K_{SEAF} is an anchor key derived by the ME and AUSF from K_{AUSF}. K_{SEAF} is provided by AUSF to the SEAF in the serving network.

For the Access and Mobility Management Function (AMF) in a serving network: K_{AMF} is a key derived by an ME and the Security Anchor Function (SEAF) from K_{SEAF}. K_{AMF} is further derived by an ME and source AMF when performing horizontal key derivation.

For NAS signalling: K_{NASint} is a key derived by the ME and AMF from K_{AMF}, which is used for the protection of NAS signalling with a particular integrity algorithm. K_{NASenc} is a key derived by the ME and AMF from K_{AMF}, which is used for the protection of NAS signalling with a particular encryption algorithm.

For Next Generation (NG)-RAN: K_{gNB} is a key derived by an ME and AMF from K_{AMF}. K_{gNB} is further derived by an ME and source gNB when performing horizontal or vertical key derivation. The K_{gNB} is used as K_{eNB} between the ME and gNB.

Keys for UP (uplink) traffic: K_{UPenc} is a key derived by an ME and gNB from K_{gNB}, which is used for the protection of UP traffic with a particular encryption algorithm. K_{UPint} is a key derived by ME and gNB from K_{gNB}, which is used for the protection of UP traffic between ME and gNB with a particular integrity algorithm.

Keys for RRC signalling: K_{RRCint} is a key derived by an ME and gNB from K_{gNB}, which is used for the protection of RRC signalling with a particular integrity algorithm. K_{RRCenc} is a key derived by the ME and gNB from K_{gNB}, which is used for the protection of RRC signalling with a particular encryption algorithm.

Intermediate keys: NH is a key derived by an ME and AMF to provide forward security. K_{NG-RAN} * is a key derived by ME and NG-RAN (gNB or ng-eNB) when performing a horizontal or vertical key derivation as specified in Clause 6.9.2.1.1 of TS 33.501 using a KDF. K_{AMF}′ is a key that can be derived by ME and AMF when the UE moves from one AMF to another during inter-AMF mobility as specified in Clause 6.9.3 of TS 33.501.

In some implementations, the NE 102 transmits at least one of the keys for UP traffic and/or RRC signalling to the UE 104 at 205. The at least one key may be transmitted at 205 in a protected RRC message.

The NE 102 transmits a resource grant for uplink transmissions to the UE 104 at 210. The grant may be a a configured grant (CG), or a dynamic grant transmitted in Downlink Control Information (DCI), for example. The grant may specify time and frequency resources associated with the granted uplink transmission. As explained in more detail below, in some implementations, the UE 104 may use one or both of the time and frequency resources associated with the grant received at 210 to protect lower-level information that is transmitted in an uplink signal transmitted using time and frequency resources of the grant.

The UE 104 may perform one or both of ciphering at least one MAC-CE at 215 and ciphering L1, or PHY layer, information at 220. The L1 information may be typical cellular traffic such as text or image information that the UE 104 wishes to deliver to the network in a Physical Uplink Shared Channel (PUSCH), for example. The UE 104 may protect the L1 information and at least one MAC-CE by ciphering the L1 information and MAC-CE using a security key. In various implementations, the L1 information that is protected at 220 may be select information such as potentially sensitive information, information that is designated by a user, or all information.

In some implementations, the UE 104 may use a security key for UP traffic as described above. For example, the UE 104 may use K_{UPenc} or K_{UPint} to cipher one or both of the L1 information and at least one MAC-CE. In addition or as an alternative, the UE 104 may use a security key for RRC signalling as described above. For example, the UE 104 may use K_{RRCint} or K_{RRCenc} to cipher one or both of the L1 information and at least one MAC-CE.

In some implementations, the UE 104 generates at least one new key for ciphering. The new key may be generated by the UE 104 from the K_{gNB} key, for example. Other implementations are possible. Examples of three possible new keys that may be generated by the UE 104 based on the K_{gNB} key, K_{MACCE}, K_{L1}, and K_{MAC-I}, can be seen in FIG. 3.

The UE 104 may generate a single new key that is used for ciphering the MAC-CE and the L1 information, or generate two different keys for each respective ciphering operation 215 and 220. In one implementation, the UE 104 generates a new key and uses the new key to cipher the MAC-CE at 215 and cipher the L1 information at 220. In another implantation, the UE 104 generates a first new key for ciphering the MAC-CE (e.g., K_{MACCE}) at 215 and generates a second new key (e.g., K_{L1}) for ciphering the L1 information at 220.

In some implementations, new keys are generated by the NE 102 and transmitted to the UE 104 at 205. Accordingly, new keys for ciphering a MAC-CE and L1 information may be generated by one or both of the NE 102 and UE 104 in various implementations.

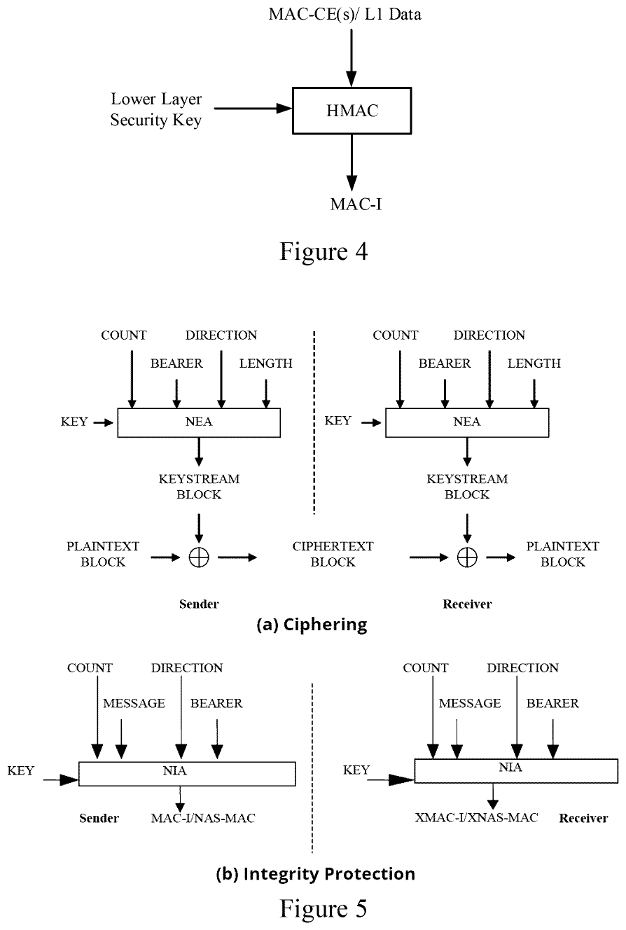

The UE 104 may generate at least one Message Authentication Code for Integrity (MAC-I) at 225. FIG. 4 illustrates an example of generating a MAC-I in accordance with aspects of the present disclosure. As illustrated in FIG. 4, a MAC-I may be generated from the output length of a Hash-based Message Authentication Code (HMAC) function, e.g. 256 bits in case of HMAC-SHA256, which is commonly used in 3GPP.

In some implementations, the output length of the HMAC function may be truncated to a shorter length, e.g. 32 bits, for a short MAC-I by using the most or least significant bits of the HMAC function as the MAC-I. Accordingly, bit lengths of the MAC-I are not limited to the 256 bit length of HMAC-SHA256, and may be less than 256 bits to reduce overhead, for example.

In other implementations, integrity protection may use a different algorithm such as NIA1, NIA2, or NIA3. Similarly, for ciphering a MAC-CE or L1 information at 215 and 220, potential algorithms include NEA0 (null ciphering), 128-NEA1 (SNOW 3G based), 128-NEA2 (AES in CTR mode), and 128-NEA3 (ZUC based). 256-bit algorithms may also be used in some implementations. Persons of skill in the art will recognize that these algorithms are merely examples, and other algorithms are possible.

The security key, or integrity protection key, used for generating the MAC-I at 225 may be an existing key such as a key for UP or RRC traffic, or a new key (e.g., K_{MAC-I}), which may be generated by the UE 104 or generated by the NE 102 and transmitted to the UE 104 at 205 in different implementations.

The at least one ciphered MAC-CE and at least one MAC-I are transmitted from the UE 104 to the NE 102 at 230 in a packet, and the NE 102 deciphers the at least one ciphered MAC-CE at 240. In some implementations, a single MAC-I is transmitted along with multiple MAC-CEs in a single packet, such that the packet includes a plurality of MAC-CEs and only one MAC-I. In such an implementation, the NE 102 may use the single MAC-I to verify integrity of all MAC-CEs in the packet at 250.

In another implementation, multiple MAC-Is are included in the same packet with multiple MAC-CEs at 230, and each MAC-I is associated with a corresponding MAC-CE. In this implementation, the NE 102 may use a separate MAC-I to verify the integrity of each individual MAC-CE at 250.

The UE 104 transmits ciphered L1 information and at least one MAC-I to the NE 102 at 235, and the NE 102 deciphers the L1 information at 245. A packet with the ciphered L1 information transmitted at 235 may include only one MAC-I. In another implementation, the packet includes a plurality of MAC-Is respectively associated with different L1 information within the packet.

In one implementation, the transmissions at 230 and 235 are separate transmissions of different packets. In another implementation, the transmissions at 230 and 235 a single transmission using a single packet. Accordingly, ciphered L1 data may be transmitted in the same packet or a different packet from at least one ciphered MAC-CE. The packet (or packets) may be transmitted at the time and frequency resources of a grant received by the UE at 210.

In some implementations, additional information may be used to cipher the MAC-CE and/or the L1 information at 215 and 220, and to generate the MAC-I at 225. FIG. 5 illustrates an example of ciphering and integrity protection using information in addition to a security key in accordance with aspects of the present disclosure. Aspects of FIG. 5 may be similar to ciphering and integrity protection at the PDCP layer with significant differences as discussed below.

As illustrated in (a) of FIG. 5, a MAC-CE and L1 information may be ciphered with a keystream block based on a security key as well as a count, bearer, direction and length fields, and a MAC-I may be generated using a security key as well as a count, message, direction and bearer fields. Examples of these inputs are provided below.

For the bearer, every bearer has an identification field which may be certain (but fixed) length, e.g., 4, 5 or 6 bits long.

The direction may refer to uplink or downlink with a 1 bit value.

For integrity protection, the message may be a message associated with the MAC I, e.g., a MAC-CE or L1 information.

The length may refer to the length of the keystream block, which is the length of the input stream to be protected. If the input stream to be protected is smaller than a minimum required length, then the input stream may be repeated multiple times to make the final input a desired length. Padding may be used in addition to or as alternative to repeating the length.

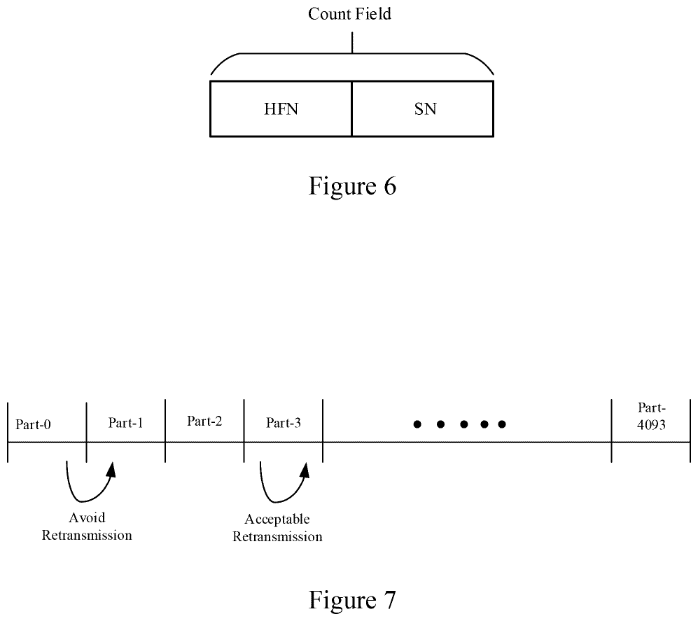

FIG. 6 illustrates an example of a count format (e.g., field or value) in accordance with aspects of the present disclosure. The count field may include a counter that ensures that with every instance of the next integrity protection or ciphering the input parameters are different even with the same integrity protection or ciphering key. The counter may be a counter that is incremented each time with the ‘next’ keystream block. In NR this may be a Sequence Number (SN) at the Packet Data Convergence Protocol (PDCP) appended with a Hyper Frame Number (HFN) value to protect against a quick wraparound of the input.

In 5G Broadband (BR), count has a length of 32 bits and is composed of a HFN and the PDCP SN. The size of the HFN part in bits may be equal to 32 minus the length of a PDCP SN. The HFN may be a state variable in which the HFN part is the number of most significant bits equal to the HFN length. The SN part, which may be another state variable, may be the number of least significant bits equal to the PDCP SN length for PDCP protection.

No SN is available for lower layer information such as a MAC-CE or L1 information. Therefore, in some implementations of the present disclosure, different information may be used for the count format, and in particular, for the SN component of the count field. In some implementations, the count field may use the subframe number of an uplink grant, e.g., the grant transmitted at 210, or the subframe number of downlink scheduling instead of the SN.

In a specific implementation, the SN component of the count field may be calculated according to the following equation: SN =SFN * 10 +Subframe Number, in which SFN is the System Frame Number.

The SFN and Subframe Number may be associated with an uplink transmission, e.g., transmission 230 or 235. The SFN and Subframe Number of those transmissions are known to the UE 104 and NE 102 and can be used to cipher and decipher MAC-CEs and L1 information without additional signaling between the UE 104 and NE 102.

In 5G NR, the System Frame Number (SFN) is a 10-bit counter that ranges from 0 to 1023, effectively representing 10.24 seconds. A radio frame has a duration of 10 ms, and is divided into 10 subframes (0 to 9), each 1 ms in length. Each subframe may contain a variable number of slots depending on the Subcarrier Spacing (SCS) or numerology. A slot, in turn, contains a fixed number of OFDM symbols, typically 14 for normal cyclic prefix, but the number of OFDM symbols may be 7 for some configurations.

Thus, using a SFN and Subframe Number to calculate a SN may use 14 bits by multiplying the SFN by 10 and adding the Subframe Number (e.g., 1024*10+9), the result of which can be encoded by 14 bits. In some implementations, other time parameters, for example slot number or starting symbol number of a transmission (e.g., transmission 230 or 235) may be used to calculate the SN by converting the SFN, Subframe Number, slot number, and/or symbol number in the absolute slot and/or symbol number to be used for the SN. The absolute number is the slot position in the radio frame/subframe and similarly, the absolute symbol number is the symbol position in the radio frame/subframe. In 5G NR, a radio frame is composed of 10 subframes, and each subframe contains a variable number of slots depending on the subcarrier spacing. Each slot, regardless of the subcarrier spacing, contains 14 OFDM symbols. The number of slots per subframe can be 1, 2, 4, 8, or 16, depending on the chosen numerology (subcarrier spacing). In an example, if there are 4 slots per subframe and the grant/schedule refers to 3^{rd} slot, then the absolute slot to be used for the said purpose is 02 (the slot range in this case is 00 to 03).

In one example, a 10 bit long counter may be used as the HFN component of a count field. In this example, the counter is incremented each time the SFN wraps around (this corresponds to 10.24*1024 seconds=174.762667 minutes of effective Discontinuous Reception (DRX) cycle), which allows 20 bits (10 for SFN Cycle and 10 for HFN) to be available for the SN. In some implementations, not all 20 bits are used for the SN component of the count field. For example, implementations may use a portion of the SFN and/or HFN (e.g., most or least significant bits). Another example is a DRX SFN Counter based on if drx-TimeReferenceSFN is included in an RRC configuration or re-configuration message received by the UE 104, as specified in TS38.321.

In some implementations, another counter may be used in addition or as an alternative to the counters described above. The number of bits in the counter may be equal to 32 or a similar value such as 16 or 64 bits (minus the length of the PDCP SN). In some implementations, GPS, GLONASS, Galileo System Time (GST) BeiDou Time (BDT), Time of Week (TOW) or other counters may be used to derive the SN component of the count field. The additional or alternative counter may be provided at a resolution of milliseconds, for example.

In some implementations, a combination of time and frequency resources may be used to derive the SN value. Generating a count field value in such implementations may be a combination of: 1) a derivation of time units such as HFN, SFN, Subframe Number, and/or frequency units such as subcarrier number or another form of frequency identification to determine an SN, and 2) a counter value such as HFN that is incremented with each SFN Cycle.

The SN calculation may be similar to a Random Access-Radio Network Temporary Identifier (RA-RNTI) calculation in 5G. An example of such a calculation is:

$$SN = 1 + s\_id + 14 \times t\_id + 14 \times 80 \times f\_id + 14 \times 80 \times 8 \times ul\_carrier \_id$$

In which s_id is the index of the first OFDM symbol of the PUSCH occasion (0≤s_id<14), t_id is the index of the first slot of the PUSCH occasion in a system frame (0≤t_id<80), where the subcarrier spacing to determine t_id is based on the value of u specified in clause 5.3.2 in TS 38.211 [8] for μ={0, 1, 2, 3}, and for μ={5, 6}, t_id is the index of the 120 kHz slot in a system frame that contains the PRACH occasion (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

This calculation would generate a 16 bit SN, which may be combined with a 16 bit SFN Cycle Counter (HFN) to generate a count field to be used as an input for security protection of one or more MAC-CE or L1 information. In some implementations, a portion of the least significant bits of the SN may be signalled in-band.

Under some circumstances, uplink transmissions are not successful, and packets are retransmitted using different resources from an original grant. Retransmissions are primarily made for MAC-CEs and not L1 information, as L1 information is not generally Hybrid Automatic Repeat Request (HARQ) retransmitted.

In the case of a retransmission, the UE 104 and NE 102 may use values for the count field associated with either resources of the original transmission grant at 210 or values of associated with the retransmission.

However, calculating a new SN for a retransmission and generating a new MAC-I or re-ciphering one or more MAC-CE and/or L1 information may be expensive from the processing perspective, and may render HARQ combining at the receiver (NE 102) side challenging since the retransmissions may be new transmissions and not entirely redundant to the earlier transmissions.

Accordingly, in some implementations, a portion of the SN (e.g., x bits) may be determined by the UE 104 and NE 102 based on the time of transmission or reception, and the remaining 14−x bits may be signalled in-band, for example, as header information associated with a MAC Transport Block (TB), set according to the initial transmission (e.g., the time of an original transmission grant at 210). This can disambiguate potential transmission and retransmission uncertainty when a NE 102 is not aware whether a transmission is the initial transmission or a retransmission.

For example, if x is equal to 0 then all 14 bits are signalled in-band (leading to 14 bits signalling load) and therefore the NE 102 knows exactly the SN used by the UE 102 upon decoding the packet, if the SN is not ciphered. On the other hand, if x is equal to 14 then no bits are signalled in-band, saving signalling load. However, if no bits are signalled the NE 102 may not be able to determine the SN component of the count field used by the initial transmission if the decoding is successful only after one or more retransmissions. Therefore, x may be a value that balances the signalling load and channel conditions (e.g., conditions which may lead to retransmissions).

In some implementations, x may be a variable that changes according to channel conditions, e.g., changes according to channel state information (CSI). In other implementations, x may be determined by the UE 104 and transmitted to the NE 102 or determined by the NE 102 and transmitted o the UE 104. In still another implementation, a value of x may be set by the network, or a fixed value that is shared by all NEs 102 and UEs 104 within a network.

FIG. 7 illustrates an example of partitioning time parts associated with a 14 bit SN in accordance with aspects of the present disclosure. A 14 bit SN results in a total of 16,384 possible time slots within the SN. If the value of x is 12, then the SN space is portioned in 4096 parts ((14−x)²) of 4 values each as shown in FIG. 7. As shown in the figure, the NE 102 may schedule a retransmission to ensure that the retransmission is made in the same time part as the original grant.

A NE 102 is aware of the precise time of an uplink transmission from a UE 104. Even if the UE 104 has not successfully received an initial grant and sees a retransmission grant as an initial grant, the NE 102 is aware that the UE 104 has missed the initial grant since the NE 102 did not receive an uplink transmission associated with the initial grant. Accordingly, there is minimal value to in-band signalling in uplink.

For downlink, the NE 102 may adapt parameters such as a Modulation and Coding Scheme (MCS), time, frequency, spatial multiplexing, etc. to ensure that all downlink transmissions associated with a packet are made in the same part of the SN space.

If a retransmission cannot be made in the same part, the NE 102 may schedule a new transmission. For example, the NE 102 may reinitiate the transmission process by transmitting a new resource grant at 210 to trigger a new SN calculation. Alternatively, the NE 102 may trigger a new SN calculation by a new transmission in a subsequent part, which may be the next part, e.g., by toggling the New Data Indicator (NDI) value.

In some implementations, only one MAC-I is transmitted in a packet with multiple ciphered MAC-CEs at 230 or multiple discrete ciphered L1 information. For example, the single MAC-I may be generated for one (e.g., the first) of the multiple MAC-CEs or the multiple L1 information. In another implementation, the single MAC-I is generated for the multiple MAC-CEs. For example, the message component of the MAC-I may be based on the combination of all ciphered MAC-CEs and/or all ciphered L1 information within the packet. In another implementation, a separate MAC-I is included for every ciphered MAC-CE and L1 information included in a packet. That is, a packet transmitted at 230 may include a plurality of MAC-CEs and a plurality of MAC-Is, and each MAC-I of the plurality of MAC-CEs is associated with a respective MAC-CE of the plurality of MAC-CEs.

In an implementation, a plurality of MAC-CEs in a packet are ciphered together. For example, the same keystream block may be used to cipher a plurality of MAC-CEs which are transmitted in the same packet at 230.

In another implementation, only a portion of a plurality of MAC-CEs in a packet are ciphered. For example, only one or two MAC-CEs, which may be sensitive MAC-CEs, are ciphered out of a plurality of MAC-CEs in a packet transmitted at 230.

In some implementations a shared secret is shared between the UE 104 and NE 102. The shared secret may be transmitted to the UE 104 by the NE 102 in a secured RRC or NAS message, for example. The shared secret may be renewed and transmitted periodically or transmitted after the use of a current shared secret. Alternatively, a list of shared secrets may be transmitted from the NE 102 to the UE 104, and the shared secrets in the list are used sequentially in order.

A shared secret itself may or may not be ciphered and/or integrity protected as disclosed above but may be included with an L1/L2 input such as a measurement report or MAC-CE before the intended transmission.

Embodiments of the present disclosure relate to ciphering and integrity protection performed in lower layers, e.g., L2 (MAC) and L1 (PHY). The ciphering may use the same or different keys for MAC and L1 information.

Security keys may be obtained in various ways including 1) using keys for UP traffic, 2) using keys for RRC signaling, 3) generating new keys from K_{gNB}, and/or generating a new key at an NE 102 and transmitting that key to a UE 104 using a protected RRC message.

A count field used for ciphering and/or integrity protection may be based on 1) time units such as HFN, SFN, and Subframe Number, and/or frequency units such as subcarrier number, or any form of frequency identification to determine an SN; and 2) a counter value such as HFN that is incremented with each SFN Cycle. A portion of bits associated with an SN for a count field may be signaled in-band to facilitate retransmissions.

If more than one ciphered MAC-CE is to be transmitted in a packet, a single MAC-I may be generated for only one MAC-CE. Alternatively, only one MAC-I may be generated and transmitted for the combination of all MAC-CEs in a packet. Accordingly, in some implementations, a packet includes a plurality of ciphered MAC-CEs and only one MAC-I. Alternatively, a respective MAC-I is generated and transmitted for each MAC-CE in a packet.

Ciphering may be applied to all MAC-CEs in a packet individually or collectively. Alternatively, ciphering may be selectively applied to only a portion of MAC-CEs in a packet, and in particular, to MAC-CEs which include potentially sensitive information.

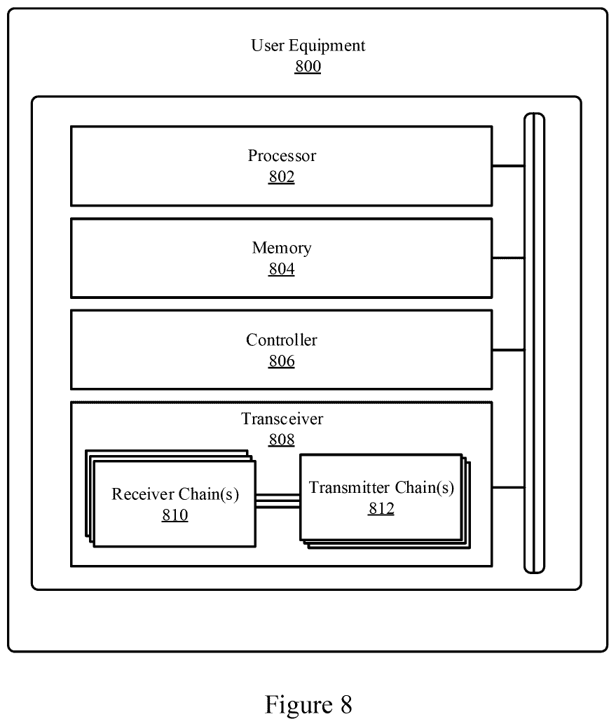

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for ciphering a MAC-CE and L1 information.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

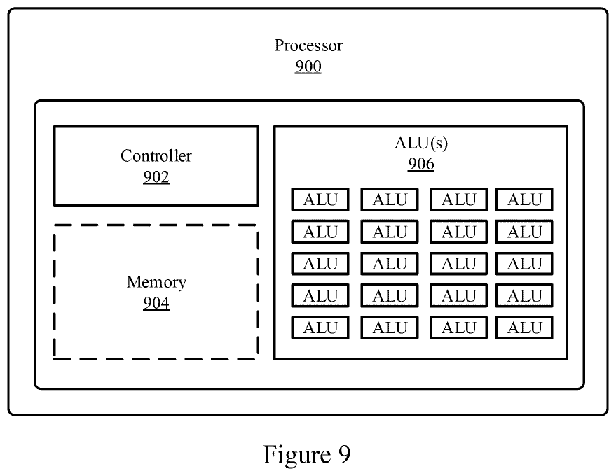

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support a means for ciphering a MAC-CE and L1 information.

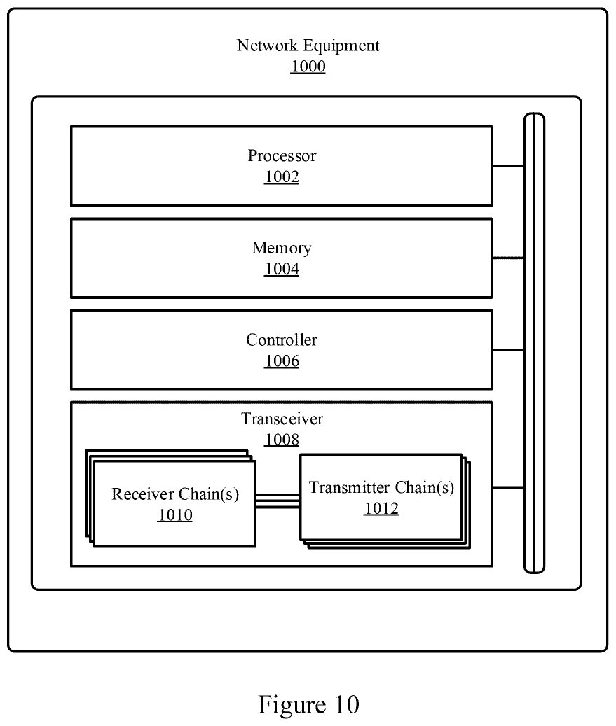

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for deciphering a MAC-CE and L1 information.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or a wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

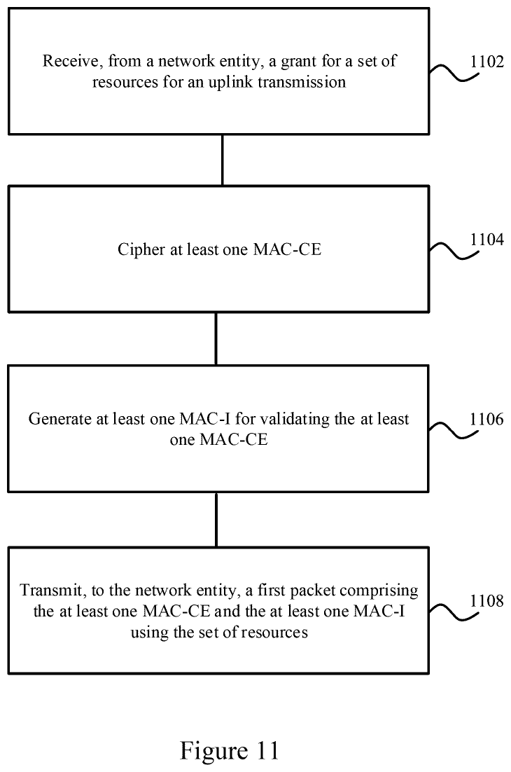

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving, from a network entity, a grant for a set of resources for an uplink transmission. The operations of 1102 may be performed in accordance with examples as described herein. In some implementations, aspects of the operations of 1102 may be performed by a UE as described with reference to FIG. 8.

At 1104, the method may include ciphering at least one MAC-CE. The operations of 1104 may be performed in accordance with examples as described herein. In some implementations, aspects of the operations of 1104 may be performed by a UE as described with reference to FIG. 8.

At 1106, the method may include generating at least one MAC-I for validating the at least one MAC-CE. The operations of 1106 may be performed in accordance with examples as described herein. In some implementations, aspects of the operations of 1106 may be performed a UE as described with reference to FIG. 8.

At 1108, the method may include transmitting, to the network entity, a first packet comprising the at least one MAC-CE and the at least one MAC-I using the set of resources. The operations of 1108 may be performed in accordance with examples as described herein. In some implementations, aspects of the operations of 1108 may be performed a UE as described with reference to FIG. 8.

It should be noted that the method described herein describes a possible implementation, and that the operations and the steps may be rearranged or otherwise modified and that other implementations are possible.

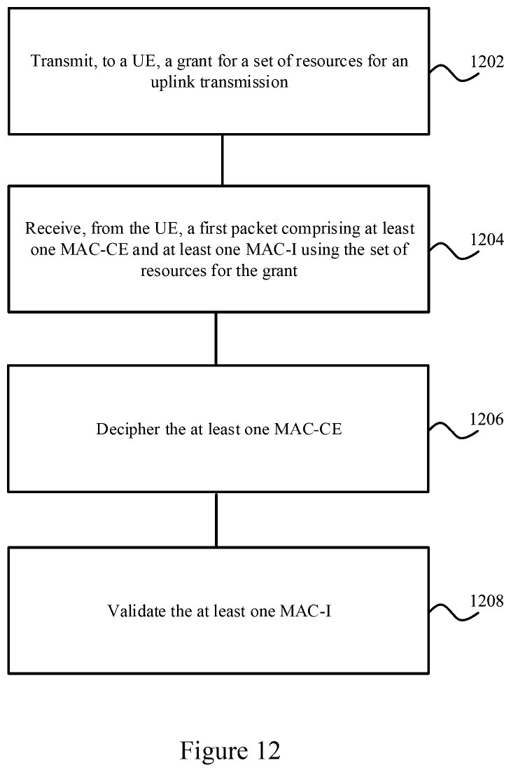

FIG. 12 illustrates a flowchart of a method in accordance with aspects of the present disclosure. The operations of the method may be implemented by a NE as described herein. In some implementations, the NE may execute a set of instructions to control the function elements of the NE to perform the described functions.

At 1202, the method may include transmitting, to a UE, a grant for a set of resources for an uplink transmission. The operations of 1202 may be performed in accordance with examples as described herein. In some implementations, aspects of the operations of 1202 may be performed by a NE as described with reference to FIG. 10.

At 1204, the method may include receiving, from the UE, a first packet comprising at least one MAC-CE and at least one MAC-I using the set of resources of the grant. The operations of 1204 may be performed in accordance with examples as described herein. In some implementations, aspects of the operations of 1204 may be performed by a NE as described with reference to FIG. 10.

At 1206, the method may include deciphering the at least one MAC-CE. The operations of 1206 may be performed in accordance with examples as described herein. In some implementations, aspects of the operations of 1206 may be performed a NE as described with reference to FIG. 10.

At 1208, the method may include validating the at least one MAC-I. The operations of 1208 may be performed in accordance with examples as described herein. In some implementations, aspects of the operations of 1208 may be performed a NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive, from a network entity, a grant for a set of resources for an uplink transmission;
cipher at least one medium access control-control element (MAC-CE);
generate at least one message authentication code for integrity (MAC-I) for validating the at least one MAC-CE; and
transmit, to the network entity, a first packet comprising the at least one MAC-CE and the at least one MAC-I using the set of resources.

2. The UE of claim 1, wherein the at least one MAC-CE is ciphered according to a keystream block.

3. The UE of claim 2, wherein the keystream block is based at least in part on a system frame number (SFN) associated with the grant.

4. The UE of claim 3, wherein the keystream block is based at least in part on a sequence number (SN) calculated according to the following equation:
$$SN = SFN * 10 + Subframe Number .$$

5. The UE of claim 2, wherein the keystream block is based at least in part on a time resource of the grant and a header of the first packet.

6. The UE of claim 2, wherein the keystream block is based at least in part on a frequency resource of the grant.

7. The UE of claim 1, wherein the at least one MAC-I is generated based at least in part on a system frame number (SFN) associated with the grant.

8. The UE of claim 7, wherein the at least one MAC-I is based at least in part on a Sequence Number (SN) calculated according to the following equation:
SN=SFN*10+Subframe Number.

9. The UE of claim 1, wherein the first packet includes a plurality of MAC-CEs and one MAC-I.

10. The UE of claim 1, wherein the first packet includes a plurality of MAC-CEs and a plurality of MAC-Is, and wherein each MAC-I of the plurality of MAC-Is is associated with a respective MAC-CE of the plurality of MAC-CEs.

11. The UE of claim 1, wherein the one or more processors are further individually or collectively configured to cause the UE to:
cipher Layer 1 (L1) data; and
transmit, to the network entity, the ciphered L1 data in a second packet comprising a second MAC-I associated with the L1 data.

12. The UE of claim 11, wherein the at least one MAC-CE and the L1 data are each ciphered according to a same cipher key.

13. A method performed by a user equipment (UE), the method comprising:
receiving, from a network entity, a grant for a set of resources for an uplink transmission;
ciphering at least one medium access control-control element (MAC-CE);
generating at least one message authentication code for integrity (MAC-I) for validating the at least one MAC-CE; and
transmitting, to the network entity, a first packet comprising the at least one MAC-CE and the at least one MAC-I using the set of resources.

14. The method of claim 13, wherein the at least one MAC-CE is ciphered according to a keystream block, and wherein the keystream block is based at least in part on a system frame number (SFN) associated with the grant.

15. The method of claim 14, wherein the keystream block is based at least in part on a sequence number (SN) calculated according to the following equation:
$$SN = SFN * 10 + Subframe Number .$$

16. The method of claim 13, wherein the at least one MAC-I is based at least in part on a system frame number (SFN) associated with the grant.

17. The method of claim 13, further comprising:
ciphering Layer 1 (L1) data; and
transmitting, to the network entity, the ciphered L1 data in a second packet comprising a second MAC-I associated with the L1 data.

18. A base station for wireless communication, comprising:
one or more memories; and
one or more processors coupled with the one or more memories and individually or collectively configured to cause the base station to:
transmit, to a User Equipment (UE), a grant for a set of resources for an uplink transmission;
receive, from the UE, a first packet comprising at least one medium access control-control element (MAC-CE) and at least one message authentication code for integrity (MAC-I) using the set of resources of the grant;
decipher the at least one MAC-CE; and
validate the at least one MAC-I.

19. The base station of claim 18, wherein the at least one MAC-CE is deciphered using a keystream block, and wherein the keystream block is based at least in part on a system frame number (SFN) associated with the grant.

20. The base station of claim 18, wherein the at least one MAC-I is validated based at least in part on a system frame number (SFN) associated with the grant.
